(19) United States
(12) Patent Application Publication
(10) Pub. No.: US 2019/0163680 A1
(43) Pub. Date: May 30, 2019

(54) SYSTEM ANALYSIS DEVICE, SYSTEM ANALYSIS METHOD, AND PROGRAM RECORDING MEDIUM

(71) Applicant: NEC Corporation, Tokyo (JP)

(72) Inventor: Takehiko MIZOGUCHI, Tokyo (JP)

(73) Assignee: NEC Corporation, Tokyo (JP)

(21) Appl. No.: 16/308,138

(22) PCT Filed: Jun. 5, 2017
(86) PCT No.: PCT/JP2017/020749

§ 371 Date: Dec. 7, 2018

(30) Foreign Application Priority Data
Jun. 8, 2016 (JP) 2016-114099

(51) Int. Cl. G06F 16/2458; G06F 16/2455; G06F 11/34

(52) U.S. Cl. CPC G06F 16/2465; G06F 16/2474; G06F 16/2477; G06F 2201/805; G06F 11/3419; G06F 2216/03; G06F 2201/80; G06F 16/24564

(57) ABSTRACT

Provided is a system analysis device that is able to calculate a degree of contribution of a variation pattern of time-series data to a change in state of a system, in which time dependency and spatial dependency are taken into account. A system analysis device 10 includes a detection unit 11 that detects, as a rule, a combination of observation values that is included in a plurality of pieces of time-series data and satisfies a predetermined condition, the observation values being values of indices observed while a system is operating; and a calculation unit 12 that calculates a contribution degree that is a degree of contribution of the detected rule to a change in state of the system.

### TECHNICAL FIELD

The present invention relates to a system analysis device, a system analysis method, and a program recording medium. The present invention particularly relates to a system analysis device, a system analysis method, and a program recording medium for discovering a rule on changes in time-series data for determining a state of a system.

### BACKGROUND ART

As a method for discovering a pattern of pieces of data that frequently appears in pieces of data in a database, there is a method called frequent pattern mining. The frequent pattern mining is a broadly studied method. The frequent pattern mining is called frequent item set mining or sequential pattern mining depending on a type of data in a database which is a target of processing.

When data in a database is a set of items, the frequent pattern mining discovers a pattern of a set of items that frequently appears. In this case, the frequent pattern mining is called frequent item set mining. Note that the set of items is a set including one or more elements.

NPL 1 describes “Apriori”, which is an algorithm for performing the frequent item set mining for discovering a pattern of a set of items that frequently appears from a large-scale database by using breadth-first search in such a way as to satisfy a constraint called an association rule.

Further, NPL 2 describes “PFP-Growth”, which is an algorithm for performing parallelized frequent item set mining for discovering a pattern of a set of items that frequently appears from a large-scale database by using depth-first search in such a way as to satisfy a constraint called an association rule.

When data in a database is sequential data, the frequent pattern mining discovers a pattern of sequential data that frequently appears. In this case, the frequent pattern mining is called sequential pattern mining.

PTL 1 describes a method for generating a prediction model based on a discovered variation rule, and predicting a result to be acquired based on unknown sequential data by using the generated prediction model.

Values observed by a sensor installed in an element constituting a system constantly change when the system is operating. In other words, when observation values acquired by the sensor are analyzed, time dependency of the element represented by a change in observation values over time is to be taken into account.

Further, an element constituting a system affects another element constituting the system. Therefore, when observation values acquired by the sensor are analyzed, not only time dependency of observation values, but also a dependency relationship between elements (hereinafter, also referred to spatial dependency of an element) is to be taken into account, simultaneously.

The frequent item set mining discovers a pattern of a set of items that frequently appears from a large-scale database. For example, the frequent item set mining is able to discover a pattern of a group of items that frequently appears.

In other words, when it is assumed that a set of items is a set of elements, the frequent item set mining is able to discover a dependency relationship between elements. However, the frequent item set mining is unable to discover time dependency of an element.

The, sequential pattern mining discovers a pattern of sequential data that frequently appears from a large-scale database. For example, by discovering a pattern of time-series data that frequently appears from a database, the sequential pattern mining is able to discover time dependency of an element. However, the sequential pattern mining is unable to discover a dependency relationship between elements.

As described above, when the frequent item set mining or the sequential pattern mining is used alone, a variation pattern that frequently appears, and in which both spatial dependency of an element and time dependency of an element are taken into account, is not discovered from a plurality of pieces of time-series data.

PTL 4 describes, regarding a search device for searching time-series data similar to certain time-series data, a time-series data search device that enables emphasized search on a natural frequency and an envelope component, which are considered to be important in a high frequency component, while maintaining flexibility in a time direction.

### CITATION LIST

### Patent Literature

[PTL 1] Japanese Patent Application Laid-Open Publication No. 2015-049790

[PTL 2] Japanese Patent No. 5441554

[PTL 3] Specification of European Patent Application Laid-Open Publication No. 2916260

[PTL 4] Japanese Patent Application Laid-Open Publication No. 2011-034389

### Non Patent Literature

[NPL 1] Rakesh Agrawal and Ramakrishnan Srikant, “Fast Algorithms for Mining Association Rules in Large Databases,” Proceedings of the 20th International Conference on Very Large Data Bases, ISBN: 1-55860-153-8, pp. 487-499, 1994.

[NPL 2] Haoyuan Li et al., “Pfp: parallel fp-growth for query recommendation,” Proceedings of the 2008 ACM conference on Recommender systems, ISBN: 978-1-60558-093-7, pp. 107-114, 2008.

### SUMMARY OF INVENTION

### Technical Problem

PTL 2 describes, regarding similarity search of a time-series sequence from time-series data, a time-series data similarity determination device for implementing emphasized search on a natural frequency and an envelope component, which are considered to be important in a high frequency component, while maintaining flexibility in a time direction.

PTL 3 describes a time-series analysis method for outputting, as a frequent pattern, a combination of features that is frequently extracted from time-series data.

Therefore, by applying the technique described in PTL 3 to the time-series data similarity determination device described in PTL 2, the time-series data similarity determination device is able to output, as a frequent pattern, a combination of features that is frequently extracted from similar time-series sequences.

In other words, it is possible to discover, from a plurality of pieces of time-series data whose similarity is equal to or larger than a predetermined value, a variation pattern that frequently appears, and in which both spatial dependency of an element and time dependency of an element are taken into account. Therefore, the time-series data similarity determination device described in PTL 2, to which the technique described in PTL 3 is applied, is able to solve the above-described problem.

However, in the time-series data similarity determination device described in PTL 2, and in the time-series analysis method described in PTL 3, calculating a degree of influence of a discovered variation pattern on a system is not assumed. In the time-series data search device described in PTL 4, it is not also assumed.

An example object of the present invention is to provide a system analysis device, a system analysis method, and a program recording medium which enable to calculate a degree of contribution of a variation pattern of time-series data to a change in state of a system, in which time dependency and spatial dependency are taken into account.

### Solution to Problem

A system analysis device according to an exemplary aspect of the present invention includes: detection means for detecting, as a rule, a combination of observation values that is included in a plurality of pieces of time-series data of observation values and satisfies a predetermined condition, the observation values being values of indices observed when a system is operating; and calculation means for calculating a contribution degree that is a degree of contribution of the detected rule to a change in state of the system.

A system analysis method according to an exemplary aspect of the present invention includes: detecting, as a rule, a combination of observation values that is included in a plurality of pieces of time-series data of observation values and satisfies a predetermined condition, the observation values being values of indices observed when a system is operating; and calculating a contribution degree that is a degree of contribution of the detected rule to a change in state of the system.

A computer readable storage medium according to an exemplary aspect of the present invention records thereon a program causing a computer to perform processes including: a detection process that detects, as a rule, a combination of observation values that is included in a plurality of pieces of time-series data of observation values and satisfies a predetermined condition, the observation values being values of indices observed when a system is operating; and a calculation process that calculates a contribution degree that is a degree of contribution of the detected rule to a change in state of the system.

### Advantageous Effects of Invention

According to the present invention, it is possible to calculate a degree of contribution of a variation pattern of time-series data to a change in state of a system, in which time dependency and spatial dependency are taken into account.

### BRIEF DESCRIPTION OF DRAWINGS

FIG. 1 is a block diagram illustrating a configuration example of a first example embodiment of a system analysis device 10 according to the present invention.

FIG. 2 is a flowchart illustrating operation of calculation process by the system analysis device 10 in the first example embodiment.

FIG. 3 is a block diagram illustrating a configuration example of a second example embodiment of a system analysis device 100 according to the present invention.

FIG. 4 is a flowchart illustrating operation of frequent rule detection process by the system analysis device 100 in the second example embodiment.

FIG. 5 is a block diagram illustrating a configuration example of a specific example of the system analysis device 100 according to the present invention.

FIG. 6 is an explanatory diagram illustrating an example of time-series data discretized by a time-series discretization unit 112.

FIG. 7 is an explanatory diagram illustrating an example of feature data extracted from a plurality of pieces of discretized time-series data by a feature extraction unit 113.

FIG. 8 is an explanatory diagram illustrating an example of frequent rule detection process by a frequent rule detection unit 114.

FIG. 9 is an explanatory diagram illustrating a display example of a contribution degree by a contribution rule display device 130.

FIG. 10 is an explanatory diagram illustrating a display example of a contribution rule by the contribution rule display device 130.

FIG. 11 is a diagram illustrating an example of a hardware configuration for implementing a device illustrated in each example embodiment.

### EXAMPLE EMBODIMENT

In the following, example embodiments of the present invention are described in detail with reference to the drawings. Note that directions in the drawings indicate an example, and do not limit directions of signals between blocks.

### First Example Embodiment

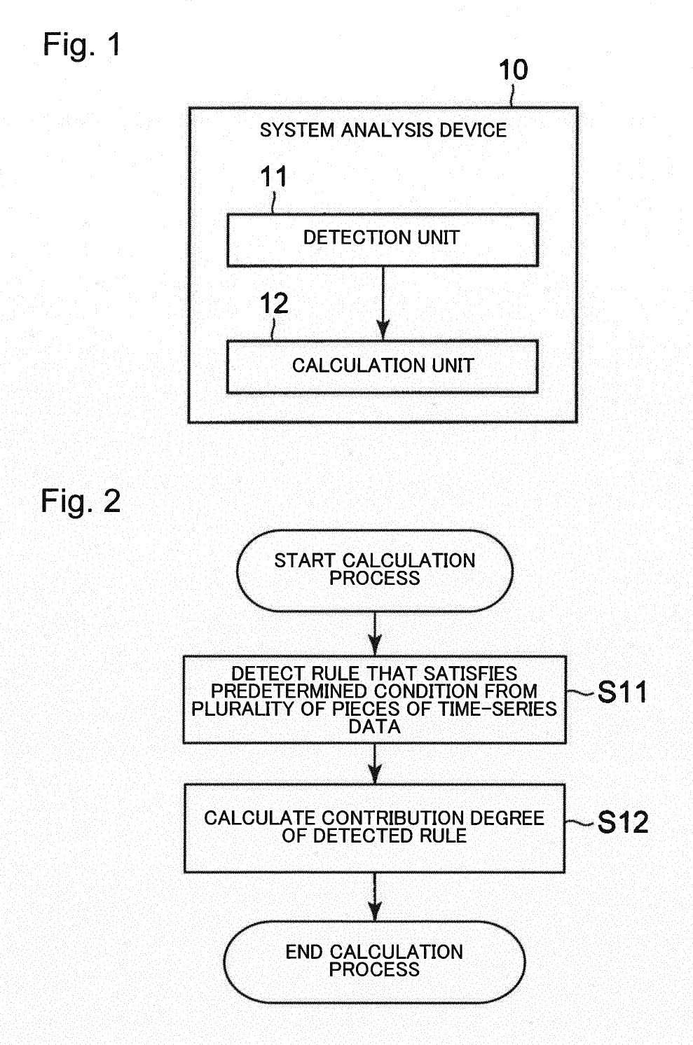

A first example embodiment of the present invention is described with reference to the drawings. FIG. 1 is a block diagram illustrating a configuration example of the first example embodiment of a system analysis device according to the present invention. A system analysis device 10 according to the present invention includes a detection unit 11 (e.g., a frequent rule detection unit 114) that detects, as a rule, a combination of observation values that is included in a plurality of pieces of time-series data and satisfies a predetermined condition, the observation values being values of indices observed while a system is operating; and a calculation unit 12 (e.g., a contribution degree calculation unit 115) that calculates a contribution degree that is a degree of contribution of the detected rule to a change in state of the system.

In the following, calculation process by the system analysis device 10 is described. FIG. 2 is a flowchart illustrating operation of calculation process by the system analysis device 10 in the first example embodiment.

A plurality of pieces of time-series data of observation values are input to the detection unit 11. The observation values are values of indices observed while a system is operating. The detection unit 11 detects, as a rule, a combination of observation values that is included in the plurality of pieces of input time-series data and satisfies a predetermined condition (Step S11). Then, the detection unit 11 inputs the detected rule to the calculation unit 12.

The calculation unit 12 calculates a contribution degree that is a degree of contribution of detected rule to a change in state of the system (Step S12). After the calculation, the system analysis device 10 ends the calculation process.

According to this configuration, the system analysis device is able to calculate a degree of contribution of a variation pattern of time-series data to a change in state of a system, in which time dependency and spatial dependency are taken into account.

Further, the system analysis device 10 may include an extraction unit (e.g., a feature extraction unit 113) that extracts feature information including an observation value included in a time range of a part of the plurality of pieces of time-series data and a time when the observation value is observed, while shifting the time range. The detection unit 11 may detect, as the rule, a combination of pieces of feature information that satisfies a predetermined condition that the combination appears in a predetermined ratio or more of sets of pieces of feature information, among sets of pieces of feature information respectively extracted from time ranges.

According to this configuration, the system analysis device is able to detect a rule by using a window which covers a part of a plurality of pieces of time-series data.

Further, feature information extracted by the extraction unit may include a name of time-series data.

Also, the system analysis device 10 may include a discretization unit (e.g., a time-series discretization unit 112) that discretizes time-series data of observation values, and the extraction unit may extract feature information from the discretized time-series data.

According to this configuration, the system analysis device is able to more easily detect a rule included in a plurality of pieces of time-series data.

Further, the discretization unit may use a symbolic aggregate approximation (SAX), as a method for discretizing time-series data.

Also, the system analysis device 10 may include a display unit (e.g., a contribution rule output unit 116 or a contribution rule display device 130) that displays a detected rule and a contribution degree of the rule together.

According to this configuration, the system analysis device is able to present a user with a rule included in a plurality of pieces of time-series data, and a contribution degree of the rule.

Further, the display unit may display a position where a detected rule appears in time-series data.

According to this configuration, the system analysis device is able to present a user with a specific content of a rule included in a plurality of pieces of time-series data.

Further, the system analysis device 10 may include an acquisition unit (e.g., an observation data collection unit 111) that acquires observation values. The acquisition unit may generate time-series data of the acquired observation values, and the detection unit 11 may detect, as a rule, a combination of observation values that is included in the plurality of pieces of generated time-series data and satisfies a predetermined condition.

According to this configuration, the system analysis device is able to detect a rule by using acquired observation values.

Further, the detection unit 11 may use, as a method for detecting a rule, a known frequent pattern mining method such as Apriori and PFP-Growth.

### Second Example Embodiment

### Description On Configuration

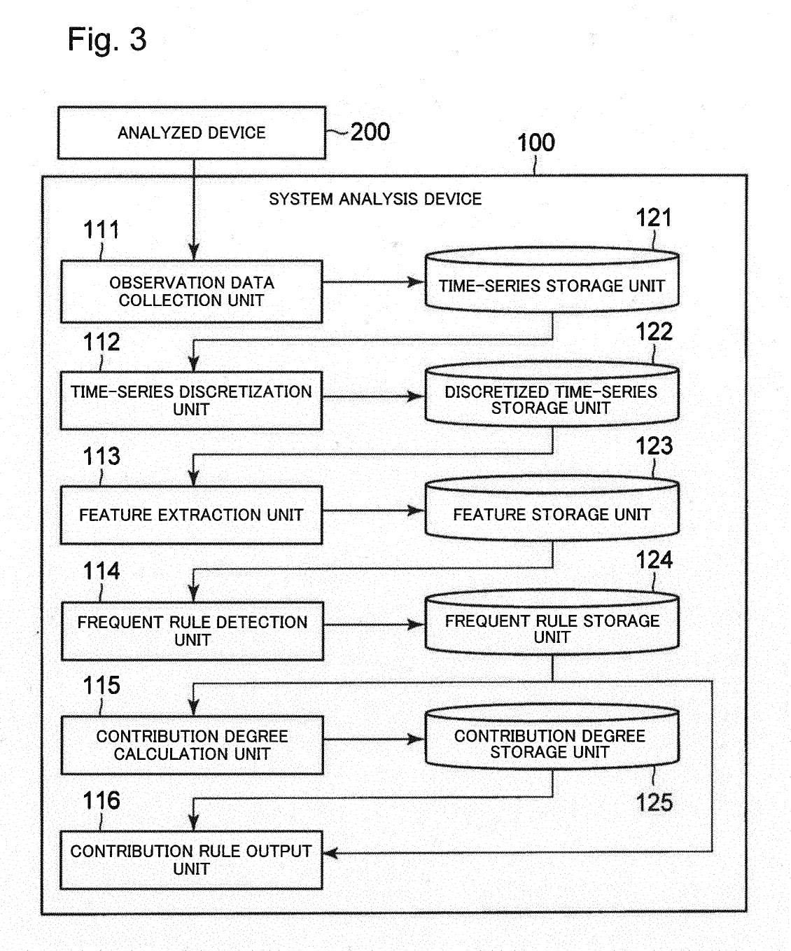

Next, a second example embodiment according to the present invention is described with reference to the drawings. FIG. 3 is a block diagram illustrating a configuration example of the second example embodiment of a system analysis device 100 according to the present invention.

The system analysis device 100 in the present example embodiment is able to identify an operation rule for determining a state of a physical system such as a power plant. The system analysis device 100 is able to discover a variation pattern for determining a state of a system based on a plurality of pieces of time-series data, while taking into account of both time dependency and spatial dependency.

In the following, an example, in which the system analysis device 100 detects a variation pattern of observation values for determining an operation state of a physical system, is described. In other words, an analyzed system in the present example embodiment is a physical system.

Note that, as far as an analyzed system is a system in which operation information of the system and a state associated with the operation information of the system are acquired, the analyzed system may be a system other than a physical system. For example, an analyzed system may be an information technology (IT) system, a plant system, a structure, a transport equipment, or the like.

When an analyzed system is an IT system, as operation information of a system, a use rate or a use amount of a computer resource or a network resource, such as, for example, a use rate of a central processing unit (CPU) and an access frequency to a disk, is used. Also, a state of the system is determined based on electric power consumption, the number of arithmetic operations, and the like.

In the present example embodiment, “time-series data” means data in which numerical values observed by a sensor are arranged, in the order of the time, at a predetermined time interval. Indices to be observed by a sensor include various indices indicating an operating state of a system, such as an adjustment value, a temperature, a pressure, a gas flow rate, and a voltage of a device.

In the present example embodiment, a “state” of a system is determined by various indices, such as, for example, an evaluation index and a performance index, which relate to a product and the like, acquired by operating the system in a condition represented by an operating state.

The present example embodiment assumes a case that there are two states, namely, a “first state” and a “second state”, as a state of a system to be analyzed. Note that three or more states may be present, as a state of a system to be analyzed. When three or more states are present, the system analysis device 100 may perform analysis process for a pair of two states selected from among all states, with respect to all possible pairs.

As illustrated in FIG. 3, the system analysis device 100 in the present example embodiment is communicably connected to an analyzed device 200. The analyzed device 200 is a device constituting a physical system to be analyzed by the system analysis device 100.

Specifically, the analyzed device 200 is a device used in production process performed in the physical system. The system analysis device 100 may be communicably connected to two or more analyzed devices.

The analyzed device 200 observes indices to be observed in the own device at a predetermined time interval. The analyzed device 200 transmits, to the system analysis device 100, observation values that are observed values. The indices to be observed include one or more indices indicating an operating state of the system, such as an adjustment value, a temperature, a pressure, a gas flow rate, and a voltage of the device.

The observation values transmitted from the analyzed device 200 are represented by a numerical value such as an integer or a decimal. The observation values may be represented by a logical value (Boolean value) such as “ON” and “OFF”, or “True” and “False”.

As illustrated in FIG. 3, the system analysis device 100 includes the observation data collection unit 111, the time-series discretization unit 112, the feature extraction unit 113, the frequent rule detection unit 114, the contribution degree calculation unit 115, the contribution rule output unit 116, a time-series storage unit 121, a discretized time-series storage unit 122, a feature storage unit 123, a frequent rule storage unit 124, and a contribution degree storage unit 125.

The observation data collection unit 111 receives observation values transmitted from the analyzed device 200. The observation data collection unit 111 inputs the received observation values to the time-series storage unit 121.

The time-series storage unit 121 stores the observation values input from the observation data collection unit 111. The time-series storage unit 121 generates time-series data constituted of input observation values of the same type, and stores the observation values in the form of the time-series data.

The time-series discretization unit 112 discretizes the time-series data. The time-series discretization unit 112 reads the time-series data stored in the time-series storage unit 121, and generates time-series data representing discrete values by discretizing the read time-series data. The number of the discrete values is equal to or smaller than a predetermined value.

In other words, the time-series discretization unit 112 discretizes continuous values of the time-series data into a finite number of discrete values. Specifically, the time-series discretization unit 112 divides the time-series data into a plurality of sections of equal width, and allocates a character to each section by referring to a representative value of the section such as an average value of the section, for example. By discretizing continuous values of the time-series data into a finite number of discrete values, the time-series discretization unit 112 is able to convert the time-series data into a set of items in which the number of types of an item is finite.

The time-series discretization unit 112 may use any method, as a method for discretizing time-series data. For example, the time-series discretization unit 112 may use, as a discretization method, an SAX that is a method for converting time-series data into a character string.

The time-series discretization unit 112 inputs the generated time-series data representing discrete values to the discretized time-series storage unit 122. The discretized time-series storage unit 122 stores the discretized time-series data input from the time-series discretization unit 112.

The feature extraction unit 113 extracts features from the discretized time-series data. The feature extraction unit 113 reads the discretized time-series data from the discretized time-series storage unit 122.

The feature extraction unit 113 extracts, from the read time-series data, information including at least information indicating a value and information indicating a time when the value is observed, as a feature, for example. The feature extraction unit 113 inputs, to the feature storage unit 123, pieces of feature data each indicating the extracted feature.

As far as information indicating a value of discretized time-series data and information indicating a time when the value is observed are included, any other information may be included in the feature to be extracted from the discretized time-series data by the feature extraction unit 113.

For example, the feature extraction unit 113 may extract, as feature data, a set (TS, t, x) including three pieces of information, namely, “TS” that is a name of the discretized time-series data, “x” that is a value of the discretized time-series data, and “t” that is a time when the value x is observed.

The feature storage unit 123 stores the extracted pieces of feature data, which are input from the feature extraction unit 113.

The frequent rule detection unit 114 detects, as a frequent rule, a pattern of pieces of feature data that frequently appears. The frequent rule detection unit 114, for example, reads all of the pieces of feature data stored in the feature storage unit 123, and detects, as the frequent rule, a pattern of pieces of feature data that frequently appears in the read feature data. The frequent rule detection unit 114 inputs the detected frequent rule to the frequent rule storage unit 124.

The frequent rule detection unit 114 uses a frequent pattern mining method in order to detect the frequent rule, for example. The frequent pattern mining method used by the frequent rule detection unit 114 may be any method, as far as a pattern of a set of items that frequently appears in a database is discovered. For example, the frequent rule detection unit 114 may use Apriori or PFP-Growth, as a frequent pattern mining method.

Frequent item set mining is a method for discovering elements that simultaneously appear. Therefore, the frequent rule detection unit 114, using the frequent item set mining is able to, by itself, take into account of a dependency relationship between elements. In other words, in the present example embodiment, detecting a frequent rule based on a plurality of pieces of feature data in the frequent rule detection unit 114 corresponds to taking into account of a dependency relationship between elements.

The frequent rule storage unit 124 stores the detected frequent rule, which is input by the frequent rule detection unit 114.

The contribution degree calculation unit 115 calculates a contribution degree that is a degree of contribution of the frequent rule to a change in state of a system. The contribution degree calculation unit 115 reads the frequent rule stored in the frequent rule storage unit 124, and calculates a contribution degree relating to the read frequent rule.

The contribution degree calculation unit 115 inputs, to the contribution degree storage unit 125, the calculated contribution degree together with identification information for identifying the frequent rule for which the contribution degree is calculated. The contribution degree storage unit 125 stores the identification information and the calculated contribution degree, which are input from the contribution degree calculation unit 115, together.

The contribution rule output unit 116 outputs the frequent rule. The contribution rule output unit 116 outputs the frequent rule in a descending order of contribution degree, for example. When the frequent rule is output in a descending order of contribution degree, the contribution rule output unit 116 reads, from the contribution degree storage unit 125, a contribution degree having a relatively large value and identification information stored together.

The contribution rule output unit 116 reads, from the frequent rule storage unit 124, a frequent rule associated with the contribution degree, by using the read identification information. The contribution rule output unit 116 outputs the read frequent rule in a descending order of contribution degree. Note that the contribution rule output unit 116 may output the frequent rule in a descending order of contribution degree by another method.

[Description on Operation]

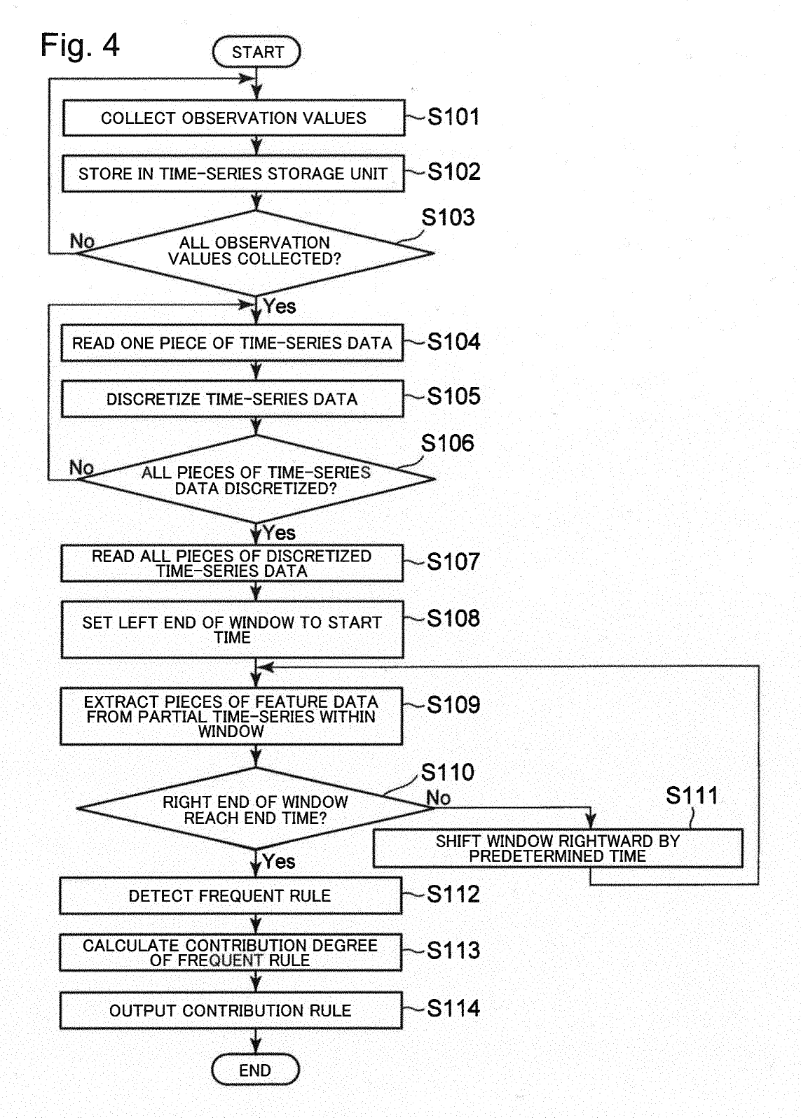

In the following, operation of the system analysis device 100 in the present example embodiment is described with reference to FIG. 4. FIG. 4 is a flowchart illustrating operation of frequent rule detection process by the system analysis device 100 in the second example embodiment.

The observation data collection unit 111 of the system analysis device 100 collects, from the analyzed device 200, sensor observation values that are values observed by a sensor (Step S101). Specifically, the observation data collection unit 111 receives sensor observation values transmitted from the analyzed device 200.

The observation data collection unit 111 stores the sensor observation values collected in Step S101 in the time-series storage unit 121 (Step S102). The time-series storage unit 121 stores the input sensor observation values in the form of time-series data.

The observation data collection unit 111 confirms whether sensor observation values relating to all pieces of performance information are collected or not (Step S103). When there are sensor observation values relating to performance information that are not yet collected (No in Step S103), the observation data collection unit 111 performs the processing from Step S101 again.

When sensor observation values relating to all pieces of performance information are collected (Yes in Step S103), the system analysis device 100 proceeds the processing to Step S104.

When sensor observation values relating to all pieces of performance information are collected (Yes in Step S103), the time-series discretization unit 112 reads, from the time-series storage unit 121, one piece of time-series data that is not yet discretized (Step S104).

The time-series discretization unit 112 discretizes the time-series data read in Step S104, and generates discretized time-series data (Step S105). The time-series discretization unit 112 stores the discretized time-series data in the discretized time-series storage unit 122.

The time-series discretization unit 112 confirms whether all pieces of time-series data stored in the time-series storage unit 121 are discretized or not (Step S106). When there is a piece of time-series data that is not yet discretized (No in Step S106), the time-series discretization unit 112 performs the processing from Step S104 again.

When all pieces of time-series data are discretized (Yes in Step S106), the system analysis device 100 proceeds the processing to Step S107.

When all pieces of time-series data are discretized (Yes in Step S106), the feature extraction unit 113 reads all pieces of discretized time-series data stored in the discretized time-series storage unit 122 (Step S107).

The feature extraction unit 113 sets a rectangle (hereinafter, referred to as a window) which covers a part of a plurality of pieces of time-series data, in such a way that a left end of the window is aligned with a vertical axis at a position corresponding to a start time of discretized time-series data (Step S108).

The feature extraction unit 113 extracts pieces of feature data from all pieces of partial time-series data included in the window (Step S109). The feature extraction unit 113 stores, in the feature storage unit 123, a set of elements constituted of all extracted pieces of feature data.

The feature extraction unit 113 confirms whether a right end of the window reaches a position corresponding to an end time of the time-series data or not (Step S110). When the right end of the window does not reach the position corresponding to the end time (No in Step S110), the feature extraction unit 113 proceeds the processing to Step S111. When the right end of the window reaches the position corresponding to the end time (Yes in Step S110), the feature extraction unit 113 proceeds the processing to Step S112.

When the right end of the window does not reach the position corresponding to the end time (No in Step S110), the feature extraction unit 113 shifts the window by a predetermined time toward the future, in other words, rightward (Step S111). After shifting the window, the feature extraction unit 113 performs the processing of Step S109 again.

When the right end of the window reaches the position corresponding to the end time (Yes in Step S110), the frequent rule detection unit 114 detects a frequent rule that is a pattern of pieces of feature data that frequently appears, based on pieces of feature data associated with each state of a system stored in the feature storage unit 123 (Step S112).

The frequent rule detection unit 114 detects a frequent rule by using frequent item set mining, for example. The frequent rule detection unit 114 stores the detected frequent rule in the frequent rule storage unit 124.

The contribution degree calculation unit 115 reads a frequent rule from the frequent rule storage unit 124, and calculates a contribution degree that is a degree of contribution of the read frequent rule to a change in state of the system (Step S113). The contribution degree calculation unit 115 stores the calculated contribution degree in the contribution degree storage unit 125.

The contribution rule output unit 116 outputs a contribution rule that is a frequent rule associated with the contribution degree calculated in Step S113, in a descending order of contribution degree (Step S114). After the output, the system analysis device 100 ends the frequent rule detection process.

By performing frequent rule detection process as described above, the system analysis device 100 is able to discover a rule on changes in time-series data for determining a state of a system. The system analysis device 100 in the present example embodiment is able to discover a variation pattern of time-series data that frequently appears, and in which both spatial dependency and time dependency are taken into account.

### SPECIFIC EXAMPLE

### Description on Configuration

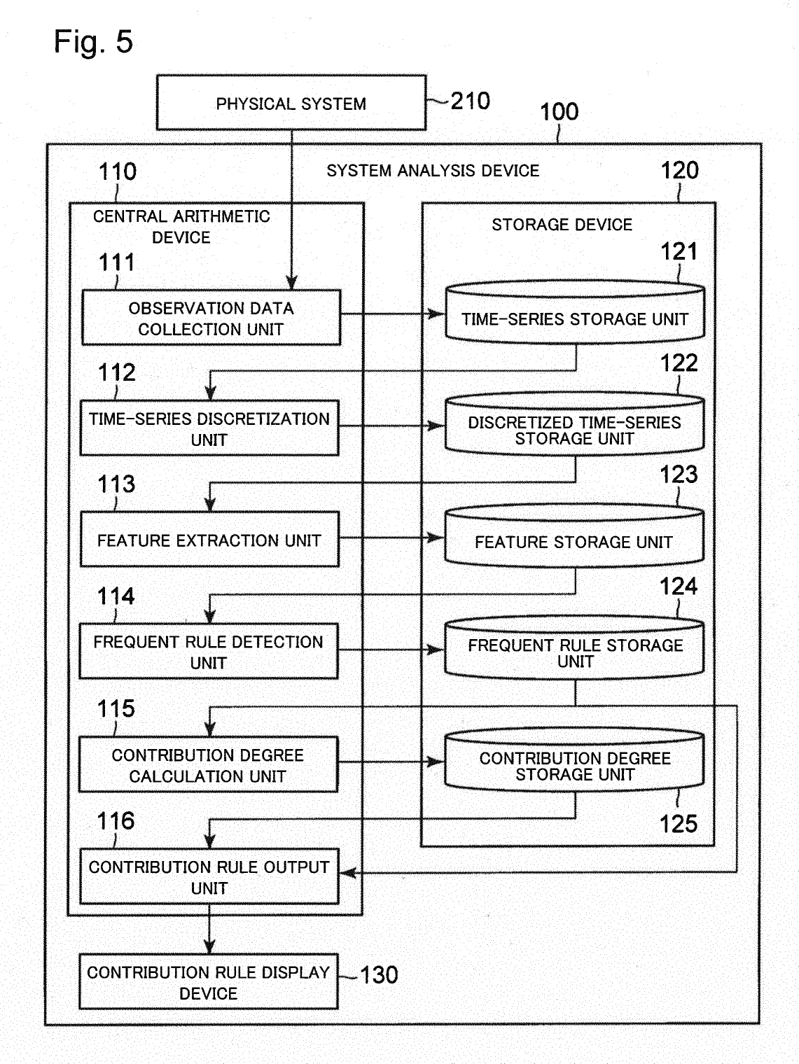

In the following, a specific example of the present invention is described with reference to the drawings. FIG. 5 is a block diagram illustrating a configuration example of the present specific example of the system analysis device 100 according to the present invention. As illustrated in FIG. 5, the system analysis device 100 in the present specific example is communicably connected to a physical system 210 in which one or more sensors are used.

As illustrated in FIG. 5, the system analysis device 100 includes a central arithmetic device 110, a storage device 120, and a contribution rule display device 130.

As illustrated in FIG. 5, the central arithmetic device 110 includes an observation data collection unit 111, a time-series discretization unit 112, a feature extraction unit 113, a frequent rule detection unit 114, a contribution degree calculation unit 115, and a contribution rule output unit 116. A function of each of the constituent elements is similar to a function of corresponding constituent element in the second example embodiment.

As illustrated in FIG. 5, the storage device 120 includes a time-series storage unit 121, a discretized time-series storage unit 122, a feature storage unit 123, a frequent rule storage unit 124, and a contribution degree storage unit 125. A function of each of constituent elements is similar to a function of corresponding constituent element in the second example embodiment.

The contribution rule output unit 116 inputs an output contribution rule to the contribution rule display device 130. The contribution rule display device 130 displays a contribution rule, which is input from the contribution rule output unit 116, in a form easily interpretable by a user.

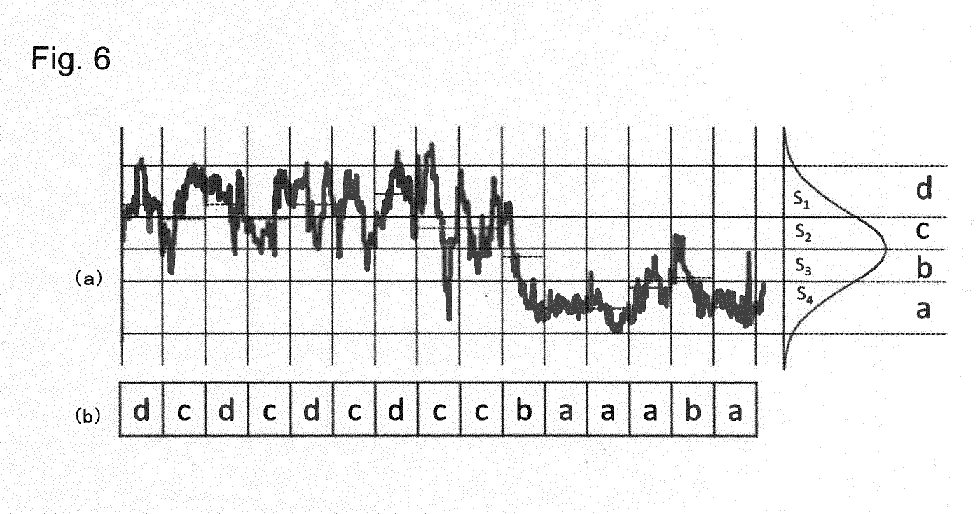

Next, an example of discretization process, feature extraction process, frequent rule detection process, contribution degree calculation process, and contribution rule display process of time-series data, according to the present specific example, is specifically described with reference to FIG. 6 to FIG. 10.

First of all, the discretization process of time-series data by the time-series discretization unit 112 is specifically described with reference to FIG. 6. FIG. 6 is an explanatory diagram illustrating an example of time-series data discretized by the time-series discretization unit 112.

In (a) of FIG. 6, time-series data before discretization is illustrated, and in (b) of FIG. 6, time-series data after discretization is illustrated. Specifically, time-series data illustrated in (b) of FIG. 6 is time-series data that is converted into a character string by an SAX.

In the following, the discretization process by the time-series discretization unit 112 is described. The time-series discretization unit 112 standardizes time-series data in such a way that the time-series data follows a normal distribution with an average 0 and a variance 1.

The time-series discretization unit 112 divides a time domain, corresponding to a horizontal width of time-series data, into a predetermined number of regions of equal width. Vertical lines illustrated in (a) of FIG. 6 indicate positions at which the time domain is divided.

The time-series discretization unit 112 calculates an average value of time-series data for each region obtained by dividing. A broken line illustrated in (a) of FIG. 6 indicates a calculated average value of time-series data in each region.

The time-series discretization unit 112 divides a value range corresponding to a vertical width of time-series data. The time-series discretization unit 112 divides the value range, in such a way that areas of respective regions of the normal distribution, associated with respective value ranges obtained by dividing, are equal to each other.

For example, S1, S2, S3, and S4 that are areas of respective regions of the normal distribution, surrounded by a straight line and a curved line illustrated in (a) of FIG. 6, are equal to each other. Horizontal lines illustrated in (a) of FIG. 6 indicate positions at which the value range is divided.

The time-series discretization unit 112 assigns alphabets “a”, “b”, “c”, and “d” to respective regions obtained by dividing of the normal distribution, from a region corresponding to a small value of time-series data.

The time-series discretization unit 112 allocates, to each of regions obtained by dividing time-series data at vertical lines, a character assigned to a region obtained by dividing at horizontal lines and to which a calculated average value of corresponding region belongs.

For example, an average value of a leading region obtained by dividing at vertical lines belongs to a region obtained by dividing at horizontal lines to which “d” is assigned. Therefore, “d” is allocated to the leading region. By executing the above-described process, the time-series discretization unit 112 acquires discretized time-series data illustrated in (b) of FIG. 6.

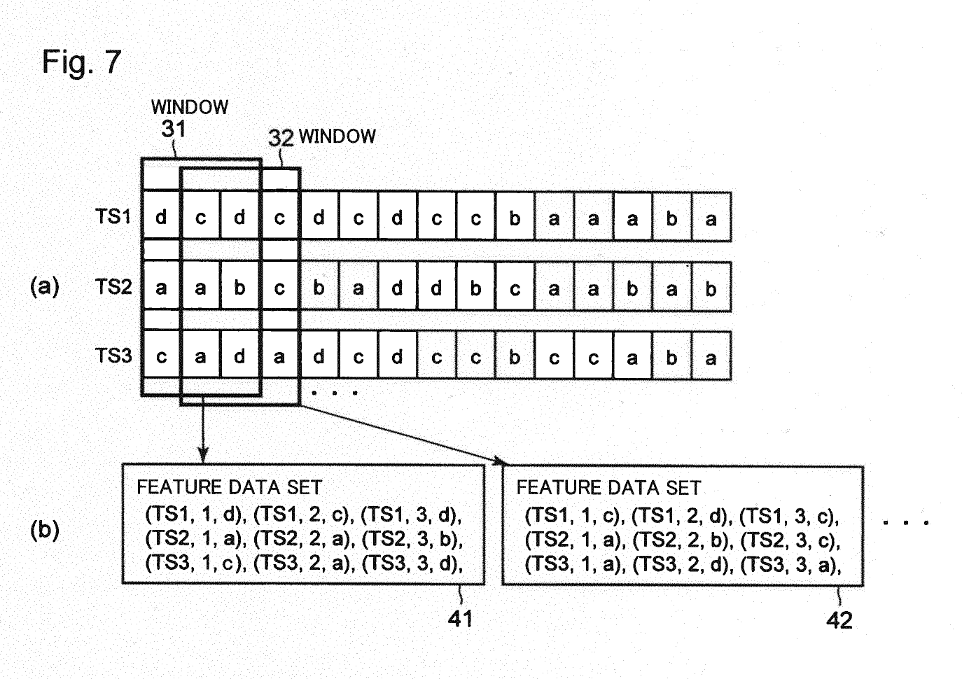

Next, the feature extraction process by the feature extraction unit 113 is specifically described with reference to FIG. 7. FIG. 7 is an explanatory diagram illustrating an example of feature data extracted, from a plurality of pieces of discretized time-series data, by the feature extraction unit 113.

In (a) of FIGS. 7, TS1 to TS3 are pieces of discretized time-series data. The feature extraction unit 113 sets a window having a predetermined width in such a way that a left end of the window is aligned with a vertical axis at a position corresponding to a start time of each piece of time-series data. A window 31 illustrated in (a) of FIG. 7 is a window set in such a way that a left end of the window is aligned with a vertical axis at a position corresponding to a start time of each piece of time-series data.

The feature extraction unit 113 extracts pieces of feature data from respective pieces of time-series data. For example, a discrete value of the time-series data TS1 within the window 31 changes in the order of “d”, “c”, “d” for each region.

Therefore, the feature extraction unit 113 is able to extract three pieces of feature data, namely, (TS1, 1, d), (TS1, 2, c), and (TS1, 3, d). Note that a first value included in a piece of feature data indicates a name of time-series data. A second value indicates a position of a region corresponding to an observation time. A third value indicates a character allocated to the region at the position indicated by the second value, and corresponding to an observation value.

As illustrated in (a) of FIG. 7, a discrete value of the time-series data TS2 within the window 31 changes in such a way that “a” appears in two consecutive regions, followed by “b”. Therefore, the feature extraction unit 113 is able to extract three pieces of feature data, namely, (TS2, 1, a), (TS2, 2, a), and (TS2, 3, b).

In (b) of FIG. 7, a set of pieces of feature data extracted from a same window is illustrated. For example, a feature data set 41 illustrated in (b) of FIG. 7 is a set of pieces of feature data extracted from the window 31. Further, a feature data set 42 is a set of pieces of feature data extracted from a window 32.

Pieces of feature data extracted from the same window are stored, as one set, in the feature storage unit 123. In other words, the feature data set 41 and the feature data set 42 illustrated in (b) of FIG. 7 are distinguishably stored in the feature storage unit 123.

The feature extraction unit 113 repeatedly performs feature extraction process, while shifting a window rightward by a predetermined number of regions. After a right end of the window reaches a position corresponding to an end time of time-series data, the feature extraction unit 113 ends the feature extraction process.

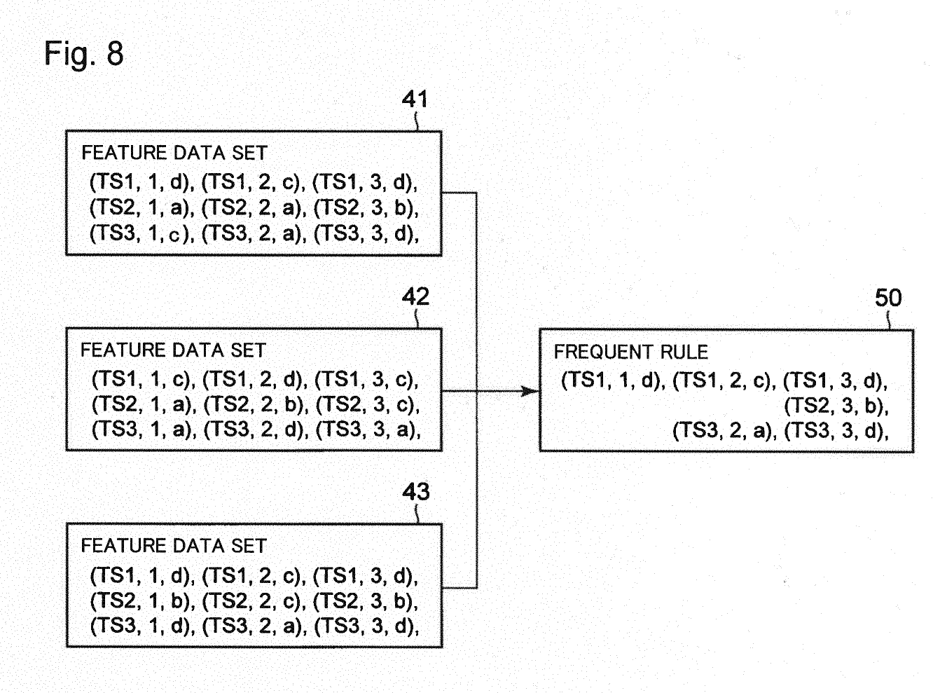

Next, frequent rule detection process by the frequent rule detection unit 114 is specifically described with reference to FIG. 8. FIG. 8 is an explanatory diagram illustrating an example of frequent rule detection process by the frequent rule detection unit 114.

The frequent rule detection unit 114 detects, as a frequent rule, a combination of pieces of feature data that simultaneously appears in a predetermined ratio or more of feature data sets, among pieces of feature data belonging to the feature data sets, for example.

For example, in the detection process illustrated in FIG. 8, the frequent rule detection unit 114 extracts pieces of feature data that simultaneously appear in two or more feature data sets, among pieces of feature data belonging to the feature data sets 41 to 43.

For example, a piece of feature data (TS1, 1, d) simultaneously appears in the feature data sets 41 and 43, thus satisfying extraction criteria. Therefore, the feature data (TS1, 1, d) is included in a frequent rule 50 illustrated in FIG. 8. Other pieces of feature data in the frequent rule 50 are also included in the frequent rule 50, for the similar reason.

Note that the frequent rule detection unit 114 may use a known frequent pattern mining method such as Apriori and PFP-Growth as the frequent rule detection process as illustrated in FIG. 8.

Next, the contribution degree calculation process by the contribution degree calculation unit 115 is specifically described. The contribution degree calculation unit 115 calculates, as a contribution degree, a correlation score between a frequent rule detected from time-series data observed for each state of the physical system 210, and the state, for example. The contribution degree calculation unit 115 may calculate a contribution degree by using mutual information, for example.

A correlation score between a frequent rule and a state is a scale representing a degree of mutual dependency between the frequent rule S and the state r. When mutual information is used, a correlation score between the frequent rule and the state is calculated by the following formula.

H(r)+H(S)−H(r, S) Formula (1)

Herein, H in Formula (1) denotes entropy. H(r, S) in Formula (1) corresponds to mutual information.

When a correlation score between a frequent rule and a state is used as a contribution degree, the contribution degree increases if the frequent rule S appears with a high probability in the state r. In other words, when the contribution degree calculated in Formula (1) is large, the frequent rule S greatly contributes to a change in state of the physical system 210 to the state r.

On the other hand, the contribution degree decreases if the frequent rule S hardly appears in the state r. Also, even if the frequent rule S appears with a high probability in the state r, in a case where the frequent rule S also appears with a high probability in another state, the contribution degree decreases. In other words, when a contribution degree calculated in Formula (1) is small, the frequent rule S hardly contributes to a change in state of the physical system 210 to the state r.

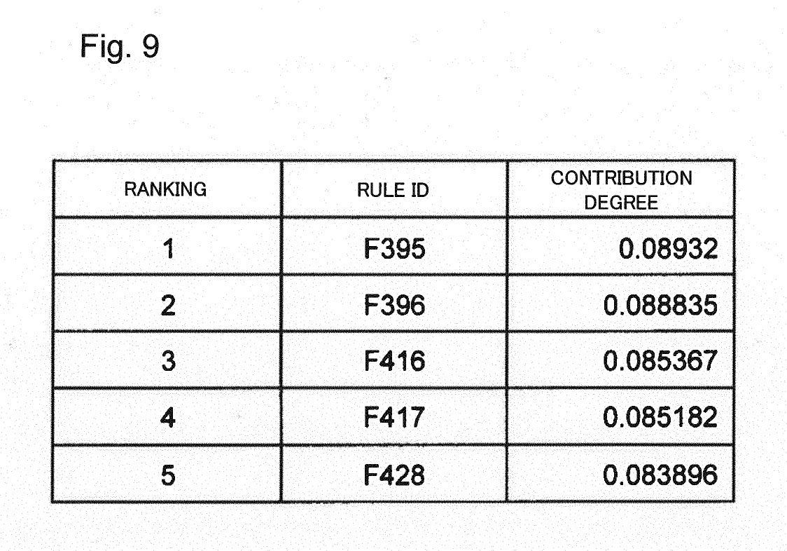

Next, the contribution rule display process by the contribution rule display device 130 is specifically described with reference to FIG. 9. FIG. 9 is an explanatory diagram illustrating a display example of a contribution degree by the contribution rule display device 130. As illustrated in FIG. 9, the contribution rule display device 130 displays a ranking, a rule ID, and a contribution degree.

The ranking illustrated in FIG. 9 is a ranking of a contribution degree within displayed frequent rules. The rule ID is identification information for identifying a frequent rule. The contribution degree is a contribution degree relating to the frequent rule indicated by the rule ID. As illustrated in FIG. 9, the contribution rule display device 130 displays frequent rules in a descending order of contribution degree from an upper side.

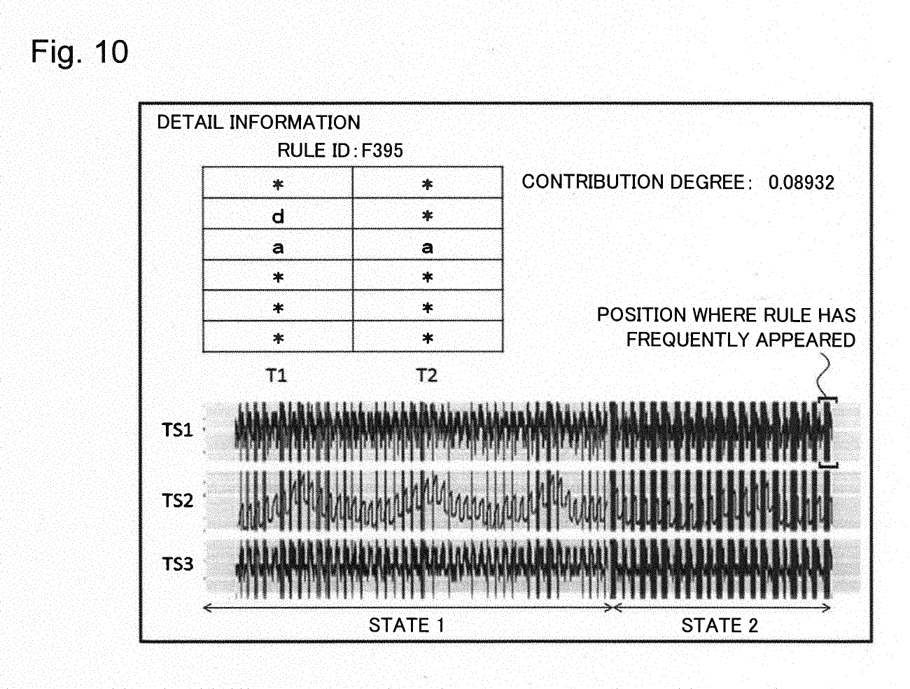

When a user selects a frequent rule displayed by the contribution rule display device 130, the contribution rule display device 130 may further display a specific content of the frequent rule, and a position where the frequent rule has appeared in the entirety of time-series data. FIG. 10 is an explanatory diagram illustrating a display example of a contribution rule by the contribution rule display device 130.

In an upper portion of FIG. 10, a content of a frequent rule of a rule ID F395 is illustrated. The rule ID “F395” means a frequent rule of 395-th type. In a lower portion of FIG. 10, positions where the frequent rule F395 has appeared in the entirety pieces of time-series data TS1 to TS3 are illustrated. Vertical lines on the time-series data TS1 to TS3 indicate positions where the frequent rule F395 has appeared.

From the content illustrated in FIG. 10, it is clear that the frequent rule F395 has more frequently appeared when the physical system 210 is in the second state, rather than in the first state. Note that the content illustrated in FIG. 9 and the content illustrated in FIG. 10 are a numerical value calculation result based on an actually performed event.

### Description on Advantageous Effects

A system analysis device according to the present example embodiment includes a time-series discretization unit that discretizes a plurality of pieces of time-series data indicating operation information of a system that is a target of processing. Further, the system analysis device includes a feature extraction unit that extracts, from partial time-series data included in a time window at a predetermined start time, a plurality of features that are information including at least information on a value of the time-series data and information on a time when the value is observed, while changing the start time of the time window. Also, the system analysis device includes a frequent rule detection unit that detects, as a frequent rule, a combination of features that is frequently extracted, and a contribution degree calculation unit that calculates a contribution degree that is a degree of contribution of the frequent rule to a change in state of a system.

The system analysis device according to the present example embodiment discretizes time-series data acquired by observing a plurality of performance indices of a system that is a target of processing, and detects a frequent rule from a set of features including an observation item, an observation time, and an observation value extracted from the discretized time-series data.

The system analysis device according to the present example embodiment is able to detect a rule on changes in value, while simultaneously taking into account of time information and spatial information. The reason for this is that both information on time and information on an observation item are included in feature data, and even if a frequent pattern mining method in which time dependency is not taken into account is used, information on time is stored in a discovered frequent pattern.

Further, the system analysis device according to the present example embodiment is able to calculate a degree of contribution of a variation pattern of time-series data to a change in state of a system, in which time dependency and spatial dependency are taken into account. The reason for this is that the contribution degree calculation unit 115 is able to calculate a contribution degree relating to a detected frequent rule, while simultaneously taking into account of time information and spatial information.

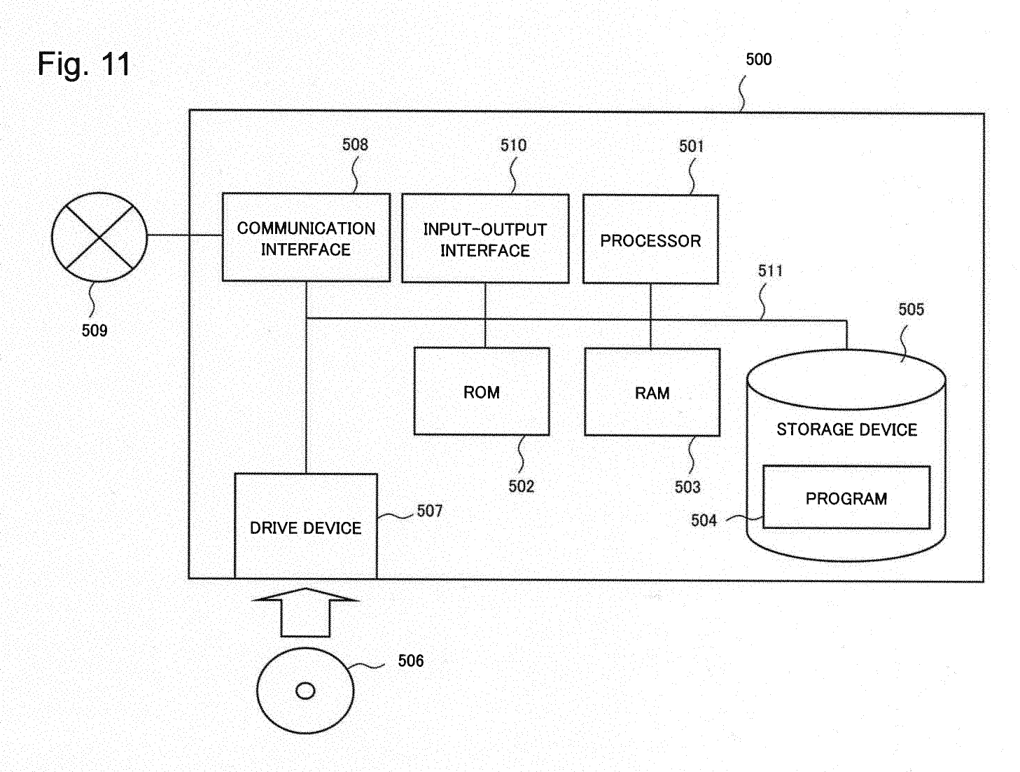

FIG. 11 is a diagram illustrating an example of a hardware configuration of a computer device 500 for implementing a system analysis device according to each example embodiment. Note that, in each example embodiment of the present invention, each constituent element of each device illustrates a block for each function. Each constituent element of each device is able to implement by using any combination of the computer device 500 as illustrated in FIG. 11 and a software, for example.

As illustrated in FIG. 11, the computer device 500 includes a processor (CPU) 501, a read only memory (ROM) 502, a random access memory (RAM) 503, a storage device 505, a drive device 507, a communication interface 508, an input-output interface 510, and a bus 511.

The storage device 505 stores a program 504 therein. The drive device 507 reads and writes with respect to a recording medium 506. The communication interface 508 is connected to a network 509. The input-output interface 510 inputs and outputs data. The bus 511 connects between respective constituent elements.

The processor 501 executes the program 504 by using the RAM 503. The program 504 may be stored in the ROM 502. Further, the program 504 may be recorded in the recording medium 506 and read by the drive device 507, or may be transmitted from an external device via the network 509. The communication interface 508 communicates data with an external device via the network 509. The input-output interface 510 communicates data with a peripheral device (a keyboard, a mouse, a display device, and the like). The communication interface 508 and the input-output interface 510 are able to function as means for acquiring or outputting data. Data such as output information may be stored in the storage device 505 or may be included in the program 504.

Note that there are various modification examples as a method for implementing each device. For example, each device is able to be implemented as a dedicated device. Further, each device is able to be implemented by a combination of a plurality of devices.

The detection unit 11, the calculation unit 12, the observation data collection unit 111, the time-series discretization unit 112, the feature extraction unit 113, the frequent rule detection unit 114, the contribution degree calculation unit 115, and the contribution rule output unit 116 in a system analysis device according to each example embodiment may be implemented by the processor 501 for executing processing in accordance with program control, for example.

Further, a method, in which a program that runs to implement these functions is recorded in the recording medium 506, the program recorded in the recording medium 506 is read as codes, and the program is executed on a computer, is also included in the scope of each example embodiment. In other words, the computer readable recording medium 506 is also included in the scope of each example embodiment. Also, it is needless to say that, not only the recording medium 506 having the above-described program recorded thereon but also the program itself is also included in each example embodiment.

Moreover, the time-series storage unit 121, the discretized time-series storage unit 122, the feature storage unit 123, the frequent rule storage unit 124, and the contribution degree storage unit 125 are implemented by the RAM 503, for example. Further, the number of storage media constituting the time-series storage unit 121, the discretized time-series storage unit 122, the feature storage unit 123, the frequent rule storage unit 124, and the contribution degree storage unit 125 may be one or more.

Also, each unit in a system analysis device according to each example embodiment may be implemented by a hardware circuit. As an example, each of the detection unit 11, the calculation unit 12, the observation data collection unit 111, the time-series discretization unit 112, the feature extraction unit 113, the frequent rule detection unit 114, the contribution degree calculation unit 115, the contribution rule output unit 116, the time-series storage unit 121, the discretized time-series storage unit 122, the feature storage unit 123, the frequent rule storage unit 124, and the contribution degree storage unit 125 is implemented by a large scale integration (LSI). Further, these units may be implemented by single LSI.

In the foregoing, the present invention is described with reference to the above-described example embodiments. The present invention, however, is not limited to the above-described example embodiments. In other words, various aspects comprehensible to a person skilled in the art, such as various combinations and selections of the above-described various disclosure elements, are applicable to the present invention within the scope of the present invention.

This application is based upon and claims the benefit of priority based on Japanese Patent Application No. 2016-114099, filed on Jun. 8, 2016, the disclosure of which is incorporated herein in its entirety by reference.

### REFERENCE SIGNS LIST

10, 100 System analysis device
11 Detection unit
12 Calculation unit
110 Central arithmetic device
111 Observation data collection unit
112 Time-series discretization unit
113 Feature extraction unit
114 Frequent rule detection unit
115 Contribution degree calculation unit
116 Contribution rule output unit
120 Storage device
121 Time-series storage unit
122 Discretized time-series storage unit
123 Feature storage unit
124 Frequent rule storage unit
125 Contribution degree storage unit
130 Contribution rule display device
200 Analyzed device
210 Physical system

1. A system analysis device comprising:
a memory storing instructions; and
one or more processors configured to execute the instructions to:
detect, as a rule, a combination of observation values that is included in a plurality of pieces of time-series data of observation values and satisfies a predetermined condition, the observation values being values of indices observed when a system is operating; and
calculate a contribution degree that is a degree of contribution of the detected rule to a change in state of the system.

2. The system analysis device according to claim 1, wherein
the one or more processors further configured to execute the instructions to: extract feature information including an observation value included in a time range of a part of the plurality of pieces of time-series data and a time when the observation value is observed, while shifting the time range, and
as the rule, a combination of pieces of feature information that satisfies a predetermined condition that the combination appears in a predetermined ratio or more of sets of pieces of feature information, among sets of pieces of feature information respectively extracted from time ranges, is detected.

3. The system analysis device according to claim 2, wherein
the one or more processors further configured to execute the instructions to: discretizes the time-series data of the observation values, and
the feature information is extracted from the discretized time-series data.

4. The system analysis device according to claim 1, wherein
the one or more processors further configured to execute the instructions to: display the detected rule and the contribution degree of the rule together.

5. The system analysis device according to claim 4, wherein
a position where the detected rule appears in the time-series data is displayed.

6. The system analysis device according to claim 1, wherein
the one or more processors further configured to execute the instructions to: acquire the observation values,
the time-series data of the acquired observation values is generated, and
as the rule, a combination of observation values that is included in a plurality of pieces of the generated time-series data and satisfies a predetermined condition is detected.

7. A system analysis method comprising:
detecting, as a rule, a combination of observation values that is included in a plurality of pieces of time-series data of observation values and satisfies a predetermined condition, the observation values being values of indices observed when a system is operating; and
calculating a contribution degree that is a degree of contribution of the detected rule to a change in state of the system.

8. The system analysis method according to claim 7, further comprising:
extracting feature information including an observation value included in a time range of a part of the plurality of pieces of time-series data and a time when the observation value is observed, while shifting the time range, wherein
the detecting detects, as the rule, a combination of pieces of feature information that satisfies a predetermined condition that the combination appears in a predetermined ratio or more of sets of pieces of feature information, among sets of pieces of feature information respectively extracted from time ranges.

9. A non-transitory computer readable storage medium recording thereon a program causing a computer to perform processes comprising:
a detection process that detects, as a rule, a combination of observation values that is included in a plurality of pieces of time-series data of observation values and satisfies a predetermined condition, the observation values being values of indices observed when a system is operating; and
a calculation process that calculates a contribution degree that is a degree of contribution of the detected rule to a change in state of the system.

10. The non-transitory computer readable storage medium according to claim 9, recording thereon the program causing the computer to perform the processes further comprising:
an extraction process that extracts feature information including an observation value included in a time range of a part of the plurality of pieces of time-series data and a time when the observation value is observed, while shifting the time range, wherein
the detection process detects, as the rule, a combination of pieces of feature information that satisfies a predetermined condition that the combination appears in a predetermined ratio or more of sets of pieces of feature information, among sets of pieces of feature information respectively extracted from time ranges.
